(19) United States
(12) Patent Application Publication
(10) Pub. No.: US 2022/0106939 A1
(43) Pub. Date: Apr. 7, 2022

(54) SYSTEM FOR GENERATING ELECTRICITY

(71) Applicant: Khamun Ward, Olton, Solihull, West Midlands (GB)

(72) Inventor: Khamun Ward, Olton, Solihull, West Midlands (GB)

(21) Appl. No.: 17/426,531

(22) PCT Filed: Jan. 28, 2020
(86) PCT No.: PCT/GB2020/050201

§ 371 Date: Jul. 28, 2021

(30) Foreign Application Priority Data
Jan. 28, 2019 (GB) 1901121.2

(51) Int. Cl. F03D 9/25; F03D 3/00; F03D 15/00; H02K 11/00; H02K 7/18; B01D 53/26; C25B 1/04; H01M 8/0656; H01M 8/04082; C25B 9/00; H01M 16/00

(52) U.S. Cl. CPC F03D 9/25; F03D 3/005; F03D 15/00; H02K 11/0094; H02K 7/183; B01D 53/265; F05B 2240/922; H01M 8/0656; H01M 8/04201; C25B 9/00; H01M 16/003; F05B 2220/706; F05B 2240/60; C25B 1/04

(57) ABSTRACT

A system (100) for producing electricity from wind energy is provided. The system comprises a balloon (110) configured for inflation with a buoyant gas. The system further comprises at least one turbine-generator system (120) coupled to the balloon, comprising a turbine and generator. The turbine is configured to rotate when subjected to an external airflow. The generator is coupled to the turbine and is configured to convert rotation of the turbine into electricity. The system further comprises an electrical storage system (230) for storing the generated electricity.

### FIELD

The invention relates to a system for generating and storing electricity using renewable energy, more particularly to a system for generating and storing electricity using wind energy.

### BACKGROUND

With the world population increasing and quality of life improving for many our energy requirements are increasing year on year. In 2016 world total final consumption of energy amounted to 9555 MTOE (IEA Key World Energy Statistics 2018). Our reliance on fossil fuels with their volatile prices and their effect on global warming and climate change requires an alternative energy source. Until now nations keen to act on reducing climate change gas emissions have predominantly explored renewable energy solutions which generate electricity. However, electrical demand accounts for only 18.8% of total energy requirements (IEA Key World Energy Statistics 2018) with renewable electricity account for only 8% of this total (IEA Key World Energy Statistics 2018). Other demands for energy include heating, hot water, cooking, transportation and industrial process. These other demands have so far been considered too costly to achieve significant progress.

Wind energy is one of the more advanced, low cost renewable energy sources currently available. However, most wind turbines only generate electricity between 30-50% of the time due to the flexible nature of low altitude wind streams. By allowing the turbine to be raised and lowered to achieve an optimum wind speed this patent offers the ability to increase this electricity generation time, therefore reducing cost to the consumer.

Cost and space requirements are restrictive considerations when constructing “ground-level” wind turbines and wind farms. To provide a sufficiently large industrial turbine requires a pylon at least 60 metres high, which has a not-insignificant cost associated with it.

Additionally, there is often significant local backlash to the construction of wind farms with the visual element often cited as one of the main reasons, along with the expected noise pollution

Off-shore wind farms ameliorate these problems to an extent, but are far from perfect. Off-shore wind farms endure significant wear and tear from the wind and waves, increasing operation and maintenance costs on top of an already significant installation cost. The off-shore location also means that the wind farms are harder to get to. This means that longer wait times are required to correct any potential problems, and the wind farms do not benefit local economies to the same extent as onshore wind farms. Further, the off-shore location cannot be used in countries with little or no coastal area.

### SUMMARY

According to a first aspect of the present invention there is provided a system for producing electricity from wind energy, the system comprising one or more balloons configured for inflation with a buoyant gas; a turbine-generator system coupled to the balloon(s), comprising one or more turbines and one or more generators. The turbine(s) is or are each configured to rotate when subjected to an external airflow, and the generator(s) is or are each coupled to the turbine and configured to convert rotation of the turbine into electricity. The system further comprises an electrical storage system for storing the generated electricity.

‘Buoyant gas’ refers to gas with lower density than air including, but not limited to, hydrogen or helium. It can be appreciated that this definition of buoyant gas may also refer to hot air. An alternative to providing a balloon filled with hydrogen/helium may be to provide a heating element at an opening of the balloon. Heating the air in the open balloon would reduce the density of said air and cause the balloon to rise, as in a hot air balloon.

The system is configured to operate substantially at or above ground level.

An advantage provided by these systems is improved yields of electricity generation per turbine over a set period of time. Above ground level, winds are relatively strong and steady, and benefit from sustained laminar flow without disruption from nearby structures (both natural and man-made). Further, increased coverage can be provided by above ground level systems, particularly if the systems are provided at high altitude.

A further advantage provided by these systems is the ease of adjusting the scale of use. For example, it is envisioned that a single household could utilise the system—something not available with conventional wind turbines, where construction costs and sheer size required to provide an efficient turbine are extremely restrictive. Alternatively, a ‘farm’ comprising a plurality of the generation systems as claimed is plausible. A ‘farm’ could comprise a plurality of separate systems spaced apart (analogous to a conventional wind farm. Alternatively, a ‘farm’ could comprise one or more tethers/anchor points with multiple balloons and turbine-generator systems at various altitudes. Each balloon and turbine-generator system could be coupled to the electrical storage system with a separate power cable (and optionally a load cable), or could be aligned in series sharing said cable(s).

Further, the system is expected to be more aesthetically pleasing and quieter than a standard wind farm. Hot air balloons, which the system may resemble from a distance, are generally considered to be pleasant to look at. It is expected that the disclosed system will also have significantly lower levels of noise (at least lower levels that can be heard from any surrounding residential areas).

The turbine may be or comprise a vertical-axis wind turbine. The vertical-axis wind turbine may comprise: a shaft aligned substantially perpendicular to a ground level; and a plurality of blades coupled to said shaft.

An advantage of using a vertical-axis wind turbine is that it does not need to be pointed in any specific direction, which removes the need for wind-sensing and orientation mechanisms. Alternatively, a conventional horizontal-axis turbine may be used. This may increase energy produced over a set period of time, but requires orientation to be effective.

The blades may be curved, like a Darrieus turbine, or straight as with the H-rotor design. Various advantages are associated with each embodiment, such as the curved blades providing better efficiency overall, but the straight blades are subject to lower blade bending stress, and so require lower maintenance costs. Alternatively, helical blades may be used. Helical blades spread the torque evenly over the entire revolution, preventing destructive pulsations and reducing wear on the turbine. It can be appreciated that other blade configurations, such as ‘scoop’ blades, can be selected dependent on requirements of use.

The generator may be mechanically coupled to the shaft of the turbine. This configuration maximises the efficiency of the turbine-generator system.

The storage system may comprise a power cable coupled between the generator and the storage system. The storage system may be provided at ground level. This reduces the weight acting on the balloon, and additionally provides an anchor to the airborne system (i.e. the one or more balloon(s) and turbine-generator system). In the case of a household system, any excess generated electricity may be sold back to the National Grid akin to the household solar panel scheme in the UK.

The system may further comprise a load cable configured to anchor the turbine-generator system and balloon to the ground. The system may comprise a winch fixed at or near ground level. The load cable may be coupled to the winch, with the winch configured to wind in or wind out the load cable to adjust a vertical height of the balloon and turbine-generator system.

An advantage of providing an additional load cable is reducing the stress on the power cable. This means that material selection for the power cable may be focused on electrical conductivity rather than yield strength, ultimate tensile strength or stiffness. For example, the power cable could be made of a conductive material and in particular a metal, such as copper, which has better conductivity than stronger metals such as steel.

Providing a permanent winch as part of the system means that the system can be raised or lowered according to conditions at the time. This ensures that maximum performance can be obtained by holding the system at the optimum altitude, and raised or lowered in order to place the turbine at a height where desired wind speed is occurring (i.e. not too high or too low). The winch also makes performing any ad-hoc maintenance significantly easier, and enables the system to be lowered at any time dependent on external requirements (e.g. not running overnight due to noise constraints).

The power cable and the load cable may be the same cable and/or may be arranged in the same cable housing, for ease of manufacture and assembly. The load cable may surround the power cable.

The system may further comprise one or more vanes coupled to at least one of: the turbine; the generator; and/or the power or load cable (where present). Advantageously, where the turbine is a horizontal-axis turbine, the vane(s) will act to ensure that the turbine is pointed into the wind. Where the turbine is a vertical-axis turbine, the vane(s) will act to resist rotation force which will be produced between the turbine and generator by aligning the vane in the same direction as wind direction.

The system may further comprise a support frame coupled to the turbine-generator system. The support frame may be coupled e.g. pivotably to the power and/or load cable above and below the turbine-generator system. This may allow the turbine-generator system to rotate freely with respect to the cable(s) in order to maintain the wind turbine in an orientation substantially perpendicular to the wind direction.

Preferably the frame surrounds the blades of the turbine e.g. to encapsulate their length. Preferably the pivot is provided below the blades.

The support frame may further comprise a tilt adjustment mechanism configured to adjust the angle of the turbine relative to the vertical. The tilt adjustment mechanism may also prevent the wind turbine tilting with respect to the vertical under high-speed external airflow.

The tilt adjustment mechanism may comprise a weighted member. The member may be attached to the frame to urge the turbine-generator system to tilt such that the turbine blades face substantially perpendicularly to the external airflow. This provides a natural balancing of the wind turbine due to gravitational force. If the turbine is subject to forces exceeding the maximum force that can be balanced by the weighted member, the turbine will tilt away from the external airflow. It is likely that any force sufficient to overcome the balancing action of the weighted member could damage the turbine by driving it at too high a speed. The weighted member therefore acts as an additional safety mechanism to prevent breakage of the turbine.

Alternatively, the support frame is coupled above and below the turbine-generator system by first and second arms respectively, where the first and second arms are adjustably coupled together to form an angle therebetween, and whereby adjustment of the coupling alters the length of the first arm and the angle of the turbine-generator with respect to the second arm to cause the turbine-generator to tilt with respect to the vertical.

The system may further or alternatively comprise a positioning system for adjusting the tilt of the turbine, comprising: a gyroscope e.g. an adjustable gyroscope coupled to the support frame. The positioning system may also comprise an inclinometer configured to measure the position of the turbine relative to the vertical the positioning system may also comprise a controller communicatively coupled to the gyroscope and/or inclinometer, configured to control the gyroscope to adjust the tilt of the support frame.

Maintaining the wind turbine at an orientation perpendicular to the external airflow advantageously maximises the efficiency of the turbine—a greater area of the turbine blade interacts with the airflow. Allowing the system to pivot the turbine can help to mitigate issues with changeable wind direction, or turbulent flow.

The support frame (and any one or more of the other components of the system) may be made of a lightweight metal such as mild steel. It is envisaged that any material sufficiently strong and durable enough to withstand the forces they will be subjected to by the external airflow, and general wear associated with operating in the atmosphere. Examples of materials include, but are not limited to, mild steel, aluminium, carbon composites or any combination thereof. The frame may be weighted to substantially balance the uplift of the balloon, to prevent the cable being subject to significant constant tension. For example, the balloon may provide a lifting force of 70N and so the system as a whole may be adjusted to weight approximately 70 kg. The weight range, in some embodiments e.g. for domestic/small scale use, may be between 50-150 kg or more. In such an example, lightweight plastics such as ABS or PPE may be unsuitable. The same configuration could be scaled up to much larger scales (MW scale turbines) for larger industrial size applications e.g. substantially 1-3MW. Again, lightweight plastics materials would be unsuitable; metal materials would be more appropriate.

The load and/or power cables would be expected to be able to withstand a force significantly greater than the uplift provided by the balloon. At high altitudes, where the external air flow is at high velocity, the system may be subject to variable forces, and so the load and/or power cables may be subject to high tensile forces. In an example, it is expected that the cable(s) may require a safe load strength in the magnitude of 1-10 kN. Higher altitude systems may require a cable with a greater load strength.

The balloon(s) may surround the turbine-generator system. The balloon(s) may comprise a conduit in which the turbine-generator system is situated. The conduit may be wider at each end of the conduit than at the point the turbine-generator is situated. This advantageously directs the airflow towards the turbine.

The system may further comprise netting surrounding the balloon(s). The turbine-generator system may be directly coupled to the netting by a coupling means.

This provides the advantage of spreading the force associated with lifting the weight of the turbine-generator system across the balloon, rather than at a fixed point. This reduces the likelihood of failure of the balloon. The netting may be fine, for improved stress distribution across the surface of the balloon(s), or coarse, which may lend itself to greater integrity of the netting.

Alternatively, the turbine-generator system may be coupled to the balloon(s) without need for a net, such as via a mechanical fixing at the base of the balloon (or in the case of the turbine-generator system being situated ‘inside’ the balloon, in the internal surfaces of the conduit).

The coupling may be an electromagnetic bearing. It is envisaged that a large number of alternative couplings could be utilised, including but not limited to a standard bearing, a universal joint, or a clamp.

An advantage provided by utilising an electromagnetic bearing is the ease of decoupling when required. Other advantages include low wear of the associated parts, low vibration, and the ability to accommodate irregularities in the mass distribution automatically. This allows for adjustment to unusual conditions (such as a change of wind direction, or turbulent flow) without user input.

The turbine-generator system may further comprise a braking system. The braking system may be required when the system requires lowering for maintenance, or in the event that wind speeds exceed a safe operating speed.

The brake may be an eddy current brake. Alternatively, a standard friction brake may be utilised. An advantage of using an eddy current brake is reduced maintenance costs (due to reduced wear on the braking system), but a standard friction brake requires lower initial setup cost.

The system may further comprise a means configured to convert water to hydrogen and oxygen gas using any excess generated electricity. The means may be situated at or near ground level.

Advantageously, this provides a source of hydrogen gas for use with the balloon. This allows the system to be at least partially self-sufficient. This also provides an alternative to selling the excess electricity back to the National Grid. There are several uses for the stored hydrogen such as for heating and hot water. Alternatively, transport could be powered using the stored hydrogen as a fuel source. Furthermore, combustion of hydrogen and oxygen produces only water, thereby eliminating production of greenhouse gases associated with other conventional fuels.

The system may further comprise a water storage tank for storing water for use with the conversion means. One or more gas storage tanks may be provided for storing the hydrogen and oxygen produced by the conversion means. In the case of one gas storage tank, the tank is partitioned to keep the two gases separate. Optionally a compressor may be provided for compressing the produced hydrogen and oxygen for more efficient storage.

As an alternative to storing compressed hydrogen in a gas tank, the hydrogen could be stored as a solid. For example, the hydrogen may be reacted with metals or other elements to produce chemical hydrides and/or complex metal hydrides, or absorbed onto carbon, or reacted with nitrogen to form ammonia. This may require extra conversion steps in order to use the hydrogen in its gaseous form (e.g. water to hydrogen to hydride to hydrogen) but allows larger quantities of hydrogen to be stored in smaller volumes, at lower pressure and ambient temperature. This also makes any potential transporting of the hydrogen between locations easier.

The conversion means may be an electrolyser and/or a hydrogen fuel cell.

It is envisaged that storage containers and compressor requirements will vary based on the commercial requirements of the end user. Domestic applications are anticipated to require lower pressure and lower capacity storage tanks than industrial applications.

The system may further comprise a control system configured to adjust several characteristics of the system. These characteristics may include any one or more of, but are not limited to:
length of uncoiled cable (i.e. height of balloon);
volume of gas used to inflate the balloon;
buoyancy of said gas (i.e. mixing ratios if appropriate, or temperature adjustment of any heating element);
charging profile for the electrical storage system;
gas compression power;
hydrogen production rate;
water flow rate; and
selection of battery storage/grid export/hydrogen production for the generated electricity.

The first two characteristics allow the control system to adjust the height of the balloon and turbine-generator system, either to ensure that optimum efficiency is achieved or to lower the system if unsafe weather conditions occur or maintenance is required.

The system may further comprise at least one sensor in communication with the control system, configured to measure at least one of:
wind speed;
altitude;
pressure of stored gas; and
force acting on the balloon/load cable.

Measuring wind speed allows the control system to raise/lower the balloon until the optimum height (i.e. highest safe wind speed) is found.

The system may further comprise a secondary balloon system coupled to the turbine-generator system, e.g. as a safety measure. The secondary balloon system may comprise one or more additional balloons, and may comprise a high-pressure inflation mechanism (e.g. a compressed gas canister such as a hydrogen canister and pump) configured to inflate the one or more additional balloons on failure of or damage to the primary balloon. This failure may be detected by a rapid or not-instructed change of height of the turbine-generator system, or by a change in pressure in the primary balloon optionally above a predetermined value. On inflation of the one or more additional balloons, with a lighter than gas such as hydrogen, the control system may instigate a controlled descent procedure, which may include the winding in of the power/load cable to gradually reduce the vertical height of the balloon and turbine-generator system until at ground level.

The system may comprise one or more additional or alternative controlled descent mechanisms. This may protect the integrity of the system in the event of vandalism or accidental damage leading to the deflating of the balloon, and protect both the equipment and people who may be below the device in such instances. It may also provide an opportunity for pre-emptive maintenance of the system or to otherwise return the system to ground level.

Such a controlled descent mechanism may provide for detecting a deflation of the balloon by the control system. The controlled descent may comprise returning the device to the ground e.g. to a docking station e.g. by winding the system in via the cable(s). One or more altitude and/or pressure sensors may be provided to monitor balloon altitude/pressure. When the control system detects an unexpected decrease in altitude and/or balloon pressure, that would be an indication of balloon failure and/or damage.

The (or each) controlled descent mechanism may comprise one or more parachutes, configured to deploy when the control system detects a deflation (i.e. a failure of or damage to the primary balloon) or to return the system to the ground if/when needed. This parachute deployment acts to reduce the speed of descent of the balloon and wind turbine system. Advantageously, the deployment of parachutes requires no further input from the control system or a user.

Alternatively, the controlled descent mechanism may comprise a propeller or drone or the like (a winged or bladed device) placed above and coupled to the balloon. The drone may comprise or, rotor be a power or fuel source comprising sufficient power or fuel to enable a short time, slow descent to be carried out in the event of a balloon failure.

The system may further comprise a condenser configured to extract water from the surroundings. The system may comprise a second conversion means in fluid communication with the condenser, configured to convert the extracted water to hydrogen. The conversion means may be in fluid communication with the balloon, such that the hydrogen produced inflates the balloon. The second conversion means may be coupled to the mouth of the balloon. It is anticipated that the second conversion means and condenser are to a smaller scale than the ‘ground-level’ conversion means, configured to produce sufficient gas to maintain balloon buoyancy. This ensures that the system is self-sustaining and can mitigate the effect of leakage of gas from the balloon. The conversion means and condenser may draw power from the generator, or may be provided with a separate power source, such as a battery.

The second conversion means may be in communication with the control system, such that the second conversion means is configured to convert the water to hydrogen on receipt of a signal generated when either the balloon pressure or force acting on the load cable drop below a preset level.

According to a second aspect of the present invention there is provided a system for adjusting a height above ground level of a wind turbine, said system comprising: a balloon, for raising a wind turbine above ground level; and a winch for lowering the wind turbine towards ground level.

The balloon may be filled with buoyant gas. As with the first aspect, buoyant gas may refer to hydrogen or helium, or simply air heated by a heating element. The winch may be secured to the ground, or may be elevated as part of a fixed structure.

According to a third aspect of the disclosure, there is provided a system for producing electricity from wind energy, comprising: a primary balloon configured for inflation with a buoyant gas and at least one turbine-generator system coupled to the balloon. The coupling may be via an adjustable tether. The turbine-generator system may comprise a turbine and a generator. The turbine may be configured to rotate when subjected to an external airflow. The generator may be coupled to the turbine and configured to convert rotation of the turbine into electricity. The system may further comprise electrical storage system for storing the generated electricity. The system may further comprise a positioning system configured to move the balloon and turbine-generator system in three dimensions. The system may further comprise an external control system configured to communicatively couple to the adjustable tether and positioning system. The external control system may be configured to control at least one of the vertical distance between the primary balloon and turbine-generator system and the three-dimensional location of the balloon and turbine-generator system.

The system for producing electricity from wind energy may be tethered to the ground or other fixed structure but, especially for high altitude applications, does not need to be.

Providing a system at higher altitude could potentially increase the energy generated by the system by locating the system in regions with a stronger airflow. A system not connected to the ground can allow for more remote locations to be accessed, and adaptability of use. A system not connected to the ground could either convert energy for storage, or be associated with the powering of technologies in hard-to-access areas. Energy storage—Energy storage in the form of hydrogen or other types of storage will be located below the main hydrogen balloon.

The adjustable tether may comprise a winch communicatively coupled to the external control system.

The positioning system may comprise at least one propeller, optionally or preferably wherein the positioning system comprises a plurality of propellers, each propeller configured to urge the system in one or more directions of the horizontal plane. The set-up may be similar to an airship.

The system may further comprise at least one sensor communicatively coupled to the external control system and configured to measure at least one wind speed, force acting on the balloon/turbine and/or altitude. The control system may be automated, commanding the winch to increase or decrease the vertical distance between the turbine-generator system and the balloon or the position of said system, depending on the measurement(s) provided by the sensor. Alternatively, the external control system may be semi-automatic. For example, a user may set determined thresholds for one or more of the measured parameters. Alternatively, a user may be able to define and select the position and vertical distance manually.

The system may further comprise an auxiliary balloon coupled to the turbine-generator system and configured to anchor the turbine perpendicular to the external airflow. If a horizontal turbine is used, ensuring that the turbine faces such that the blades are perpendicular to the airflow significantly improves the efficiency of the system. The auxiliary balloon and turbine-generator system can be positioned either above and in front of the primary balloon or behind and below, depending upon atmospheric conditions.

Each of the primary and auxiliary balloon may further comprise a portable condenser and conversion means configured to extract and convert water from the atmosphere to hydrogen for use in inflating the balloon(s), as described with respect to the first aspect. Each balloon comprising its own condenser/conversion means mitigates possible issues associated with gas leakage from either balloon.

Features which are discussed in the context of separate aspects and/or embodiments of the invention may be used together and/or be interchangeable. Similarly, where features are, for brevity, described in the context of a single embodiment, these may also be provided separately or in any suitable sub-combination. Features described in connection with the system may have corresponding features definable with respect to a method of use, and these embodiments are specifically envisaged.

These and other aspects of the invention will be apparent from, and elucidated with reference to, the embodiments described hereinafter.

### BRIEF DESCRIPTION OF DRAWINGS

Embodiments will be described, by way of example only, with reference to the drawings, in which

FIG. 1 illustrates a schematic of an example embodiment of the system;

FIG. 2 illustrates a schematic of an alternative embodiment of the system;

FIG. 3 illustrates a schematic of a storage unit according to an example embodiment;

FIG. 4 illustrates a schematic of a coupling mechanism according to an example embodiment of the system;

FIG. 5 illustrates a schematic of a tilt adjustment mechanism according to an example embodiment of the system; and

FIG. 6 illustrates a schematic of an alternative system according to an example embodiment of the invention.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar features in modified and different embodiments.

### DETAILED DESCRIPTION OF EMBODIMENTS

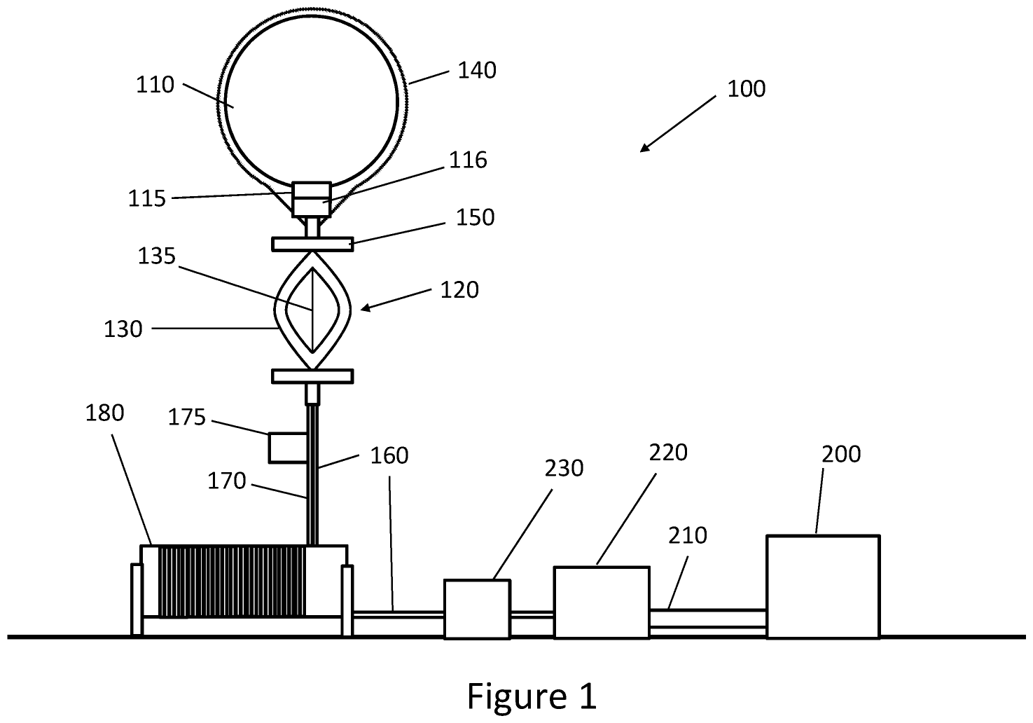

FIG. 1 illustrates a schematic of an example embodiment of the system 100. The system 100 comprises a balloon 110 configured for inflation, surrounded by netting 140. In the illustrated example, the balloon 110 is approximately spherical, but any reasonable shape is envisaged. A turbine-generator system 120 is coupled to the netting 140 via a coupling means 150. In a case where netting 140 is not provided as part of the system 100, the coupling means 150 may attach directly to the balloon 110. The coupling means 150 may be or comprise a magnetic bearing, or a standard bearing. The turbine-generator system 120 comprises a vertical-axis turbine 130 with a shaft 135 and a generator (not shown) coupled to the shaft 135. The turbine 130 is configured to rotate when subjected to an external airflow, and the generator configured to convert said rotation into electricity. The turbine-generator system 120 may also comprise a braking system (not shown). This may be an integral part of the coupling means 150 (e.g. if a magnetic bearing is used), or a separate component. This generated electricity is stored in electrical storage system 230.

The generator is connected to the electrical storage system 230 via a power cable 160. The system may also include a load cable 170. The load cable 170 anchors the turbine-generator system 120 and balloon 110 to the ground. In the embodiment shown this is connected to a winch 180. The winch 180 is configured to wind in/out the load cable 170 (and power cable 160) to adjust the vertical height of the balloon 110 and turbine-generator system 120. The load cable 170 may be made of a higher strength and stiffness material than the power cable 160. The load cable 170 may be or comprise a metal such as steel, or other strong, lightweight material such as Kevlar rope. While the power cable 160 and the load cable 170 are separate cables in the illustrated example, however, a single cable could be used in order to, for example, save on material costs. In the illustrated example, a vane 175 is coupled to the load cable 170, but could conceivably couple to any of the turbine-generator system 120, the load cable 170 or the power cable 160.

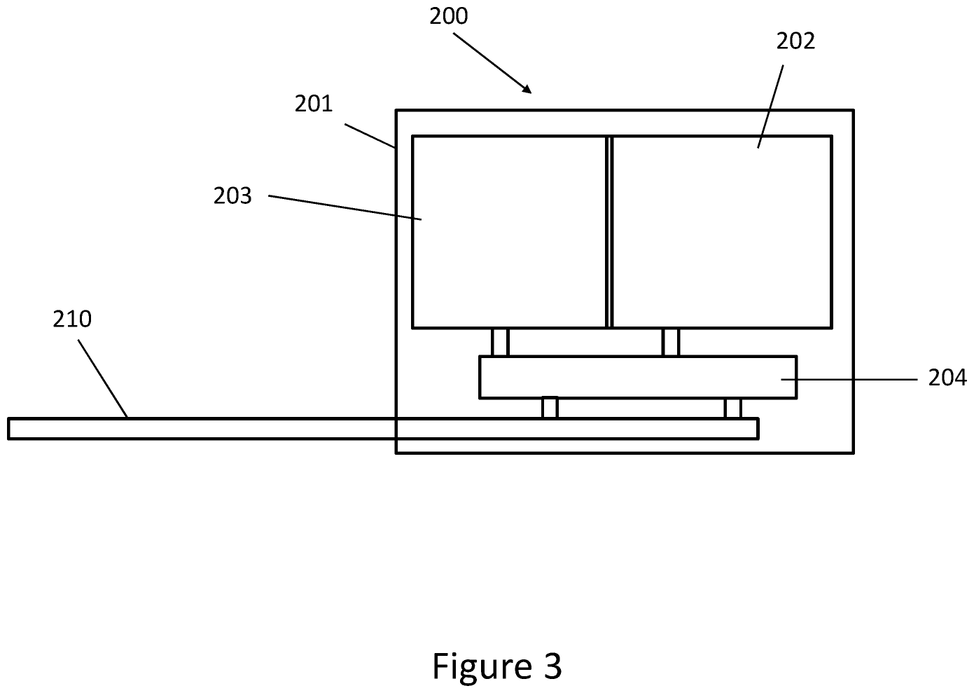

The power cable 160 passes from the winch 180 to the electrical storage system 230. The storage system may comprise a series of rechargeable batteries. In the illustrated example, electricity generated in excess of the storage capacity of the storage system is used to convert water to hydrogen and oxygen gas with conversion means 220. Conversion means 220 may be a fuel cell or electrolyser. The produced gas is piped to gas storage system 200 via piping 210. An example gas storage system 200 is described in more detail with reference to FIG. 3, but in brief may comprise a compressor 204 and one or more storage tanks 202, 203.

The system may further comprise a control system and at least one sensor (not pictured). The control system may be configured to adjust several characteristics of the system, such as the height of the balloon 110. This could be controlled directly, or indirectly by controlling the length of load cable which is uncoiled or the volume/buoyancy of gas used to inflate the balloon together or separately. The control system may also adjust the charging profile for the electrical storage system, gas compression power, hydrogen production rate, water flow rate, and may be configured to select the ‘destination’ of the generated electricity (e.g. selection of whether the generated electricity is stored/exported to the grid/used for hydrogen production). The sensor(s) may be configured to measure at least one of wind speed, altitude, pressure of stored gas, or the force acting on the balloon/load cable.

In the illustrated example, the winch 180, control system, electrical storage system 230, conversion means 220 and gas storage system 200 are separately fixed to the ground. In other examples, these components may be part of a fixed structure anchored to the ground, and individual components may be raised. As an example, the winch 180 and control system may be elevated with respect to the storage systems 200, 230 in order to make the overall system 100 more space efficient. This would be a particular consideration for a “balloon farm” (analogous to a wind farm), or where the system is used for a single household.

The system 100 may further comprise a secondary balloon system (not pictured) coupled to the turbine-generator system 120 as a safety measure. The secondary balloon system may comprise a high-pressure inflation mechanism (e.g. a hydrogen canister and pump) configured to inflate the secondary balloon on failure of or damage to the primary balloon 110. This failure may be detected by a rapid or not-instructed change of height of the turbine-generator system 120, or by a noticeable change in pressure in the primary balloon 110.

The system 100 may optionally further comprise a second conversion means 115 and condenser 116. Where implemented, the condenser 116 is configured to extract water from the surroundings of the system 100 (i.e. moisture from the air). The second conversion means 115 is in fluid communication with the condenser 116, and configured to convert the water to hydrogen. This hydrogen can be used to maintain buoyancy of the balloon 110—the second conversion means 115 is also in fluid communication with the balloon 110. A pump (not shown) may be utilised to inflate the balloon 110 with the generated hydrogen.

The second conversion means 115 and condenser 116 may be powered by the electricity generated by turbine-generator system 120. The second conversion means 115 (and condenser 116) may be in communication with the control system (not pictured), such that the second conversion means 115 is configured to convert the water to hydrogen on receipt of a signal generated by the control system, when, for example, either the balloon pressure or force acting on the load cable drop below a preset level. The second conversion means 115 and condenser 116 may be idle at other times, to reduce consumption of the generated electricity.

It is anticipated that the second conversion means 115 and condenser 116 are to a smaller scale than the ‘ground-level’ conversion means, such as 10% to 50%, and configured to only produce sufficient gas to maintain balloon buoyancy.

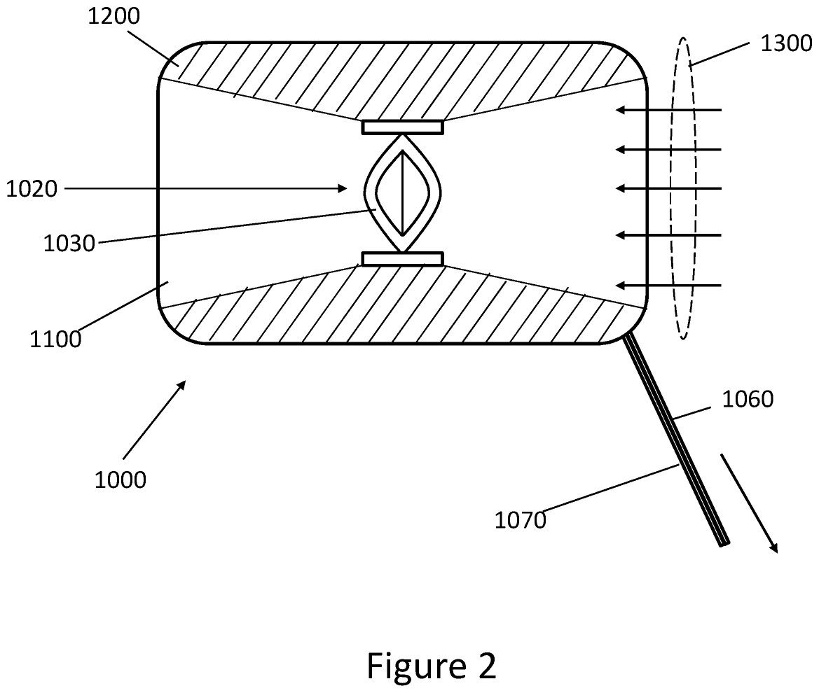

FIG. 2 illustrates an alternative embodiment. In this illustrated example, the ground-level components (not pictured) are expected to be substantially the same as the embodiment shown in FIG. 1. In this example, the balloon 1000 surrounds the turbine-generator system 1020. The balloon 1000 comprises a conduit 1100 to direct external airflow 1300 to the turbine-generator system 1020. The conduit 1100 is configured to be funnelled towards the turbine-generator system 1020 (i.e. the conduit is thinner at the point where the turbine-generator system 1020 is attached than at the ends). The section 1200, which causes the funnel-like shape of the conduit may be inflated with gas, or may be a fixed structure. Section 1200 being an inflatable portion reduces weight, and increases ease of transporting the system when not in use, but a fixed structure improves stability and ease of coupling the turbine-generator system 1020 to the balloon 1000.

The turbine-generator system 1020 is substantially similar to turbine-generator system 120. However, the turbine 1030 may be to a smaller scale, or a horizontal-axis turbine. The funnelling effect of the section 1200 would cause an increased wind speed acting on the turbine, and so a smaller turbine (e.g. approximately 50% of the size of that of the earlier embodiment) could generate the same power output. This alternative embodiment at least partially addresses any issues of alignment associated with a horizontal-axis turbine, such that it may be preferred over a vertical-axis turbine.

The load cable 1070 may be coupled directly to the balloon, with the power cable 1060 coupled to the turbine-generator system 1020. Alternatively, they may both couple to the section 1200 in the case where section 1200 is a fixed structure. A further alternative is that both cables 1060, 1070 couple to the balloon 1000, and a further electrical wire is provided from the attachment point to the turbine-generator 1020, Otherwise, the cables 1060, 1070 are substantially the same as described in FIG. 1.

FIG. 3 illustrates an example gas storage system 200. The system 200 comprises two separate tanks 202 and 203 for storing hydrogen and oxygen respectively. In an alternative embodiment, a single tank with a non-permeable partition may be used. The tanks 202 and 203 are contained inside a housing 201. A compressor 204 for compressing the oxygen and hydrogen for storage is provided. In the illustrated example, a single compressor 204 and pipe 210 is used for both gases to optimise space usage, with gases being separated before entering the compressor 204 (via separate inlets). Alternatively, a separate compressor and pipe could be used for each gas, with separation being performed at the conversion stage.

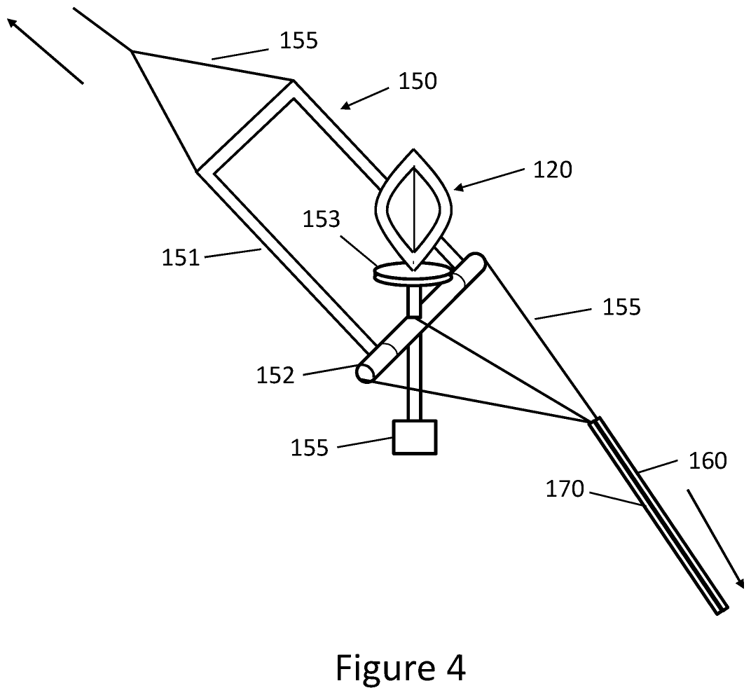

FIG. 4 illustrates an example coupling mechanism 150 for coupling the turbine-generator system 120 to the balloon (not pictured) and the power cable 160 and/or load cable 170. The coupling mechanism 150 may comprise a support frame 151, which is configured to couple above and below the turbine-generator system 120, surrounding the system 120. The frame 151 may be configured to pivotably couple to the turbine-generator system 120. In the illustrated embodiment, the base 152 of the support frame 151 is provided in three rotatably coupled sections. The middle section of the base 152 is fixed to the turbine-generator system 120 via a stand 153 oriented perpendicular to the base 152 and configured to fixedly attach to the turbine generator system. In the illustrated embodiment, a weighted member 154 is fixedly coupled to the middle section of the base 152 and disposed opposite the stand 153. This weighted member 154 acts as a balance against the turbine-generator system 120, to ensure that the turbine 130 is oriented substantially perpendicular to the external airflow. This is designed to maximise the efficiency of the turbine-generator system 120 and may be particularly useful when the external airflow is travelling at high velocity.

The outer sections of the base 152 are coupled to the remainder of the frame which is in turn coupled to the power cable 160 and/or load cable 170 via additional cables 155 below the turbine-generator system 120, and coupled the balloon 110 via additional cables 155 above the turbine-generator system 120, The middle section of the base 152, and consequently the turbine-generator system 120 and weighted member 155, can therefore rotate freely with respect to said cables 155, 160, 170. These additional cables 155 may be electrically conductive, to conduct electricity generated by the turbine-generator system 120 to the electrical storage system 230 (FIG. 1) which is fixed at or near ground level. This arrangement also allows movement of the balloon 110 relative to the point at which the power and/or load cables 160, 170 are anchored at or near ground level, without the wind turbine being tilted relative to the ground,

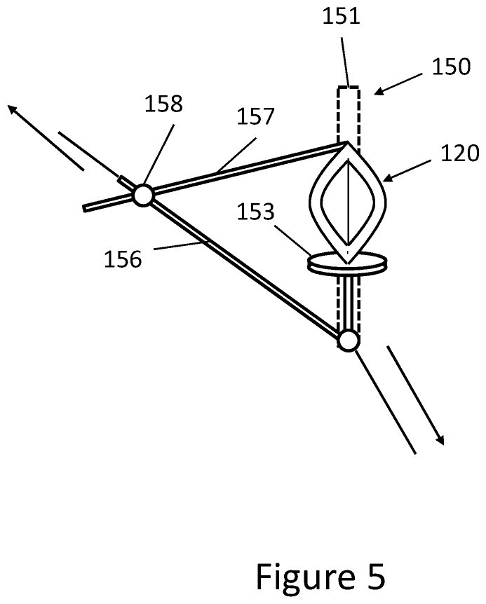

FIG. 5 illustrates a tilt-adjustment mechanism according to an example embodiment of the system. An arm 156 extends from the support frame 151 at an angle to the vertical, and is coupled to the turbine-generator system 120 with a joining member 157. Joining member 157 is fixedly attached to the turbine-generator system 120. Joining member 157 is coupled to the arm 156 with an adjustable coupling means 158 such that the length of the member 157 disposed between the arm 156 and the turbine-generator system 120 is adjustable. For example, the adjustable coupling means 158 may comprise a threaded male and female connection, such that rotation of either the male or female component changes the length of the male member that is disposed within or through the female component. Alternatively, the joining member 157 may be a cable and the adjustable coupling means 158 a winch or reel. Reducing the length of the joining member 157 tilts the turbine-generator system 120 towards the arm 156. Conversely, extending the length of the joining member 157 tilts the turbine-generator system 120 away from the arm 156. Rotation may be driven by a motor, in communication with an external control system. The arm 156 may be directly coupled to the balloon (not pictured).

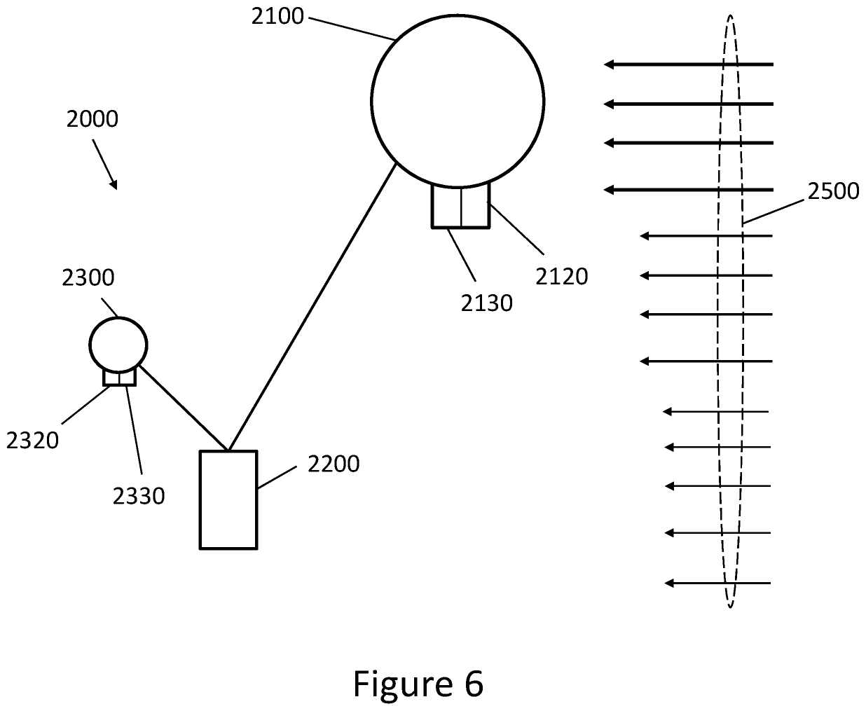

FIG. 6 illustrates a schematic diagram of a high-altitude system 2000. It is anticipated that the balloons 2100, 2300 may be spaced up to 1000 m apart in altitude. The velocity of the external airflow 2500 is greater at higher altitudes, as indicated in the figure.

The turbine-generator system 2200 is suspended between the balloons 2100, 2300. The turbine-generator system is substantially similar to the embodiment described with relation to FIG. 1, and may comprise a support frame 150 as described in FIG. 4. The turbine-generator system 2200 may operate at a different scale to that of the embodiment described in FIG. 1. For example, because it is expected to operate at higher altitudes and as such be exposed to an external airflow with higher velocity, a greater amount of electricity may be generated. Additionally, a high-altitude system does not have similar concerns of noise pollution or of being an ‘eyesore’ as a lower-altitude system easily visible from ground level. Therefore, the turbine-generator system 2200 may operate on a larger scale to turbine-generator system 120. Alternatively, the higher altitude system may be associated with and provide power to a separate system, such as a telecommunications system, in an otherwise remote and/or difficult to access area. This lower energy requirement may result in a smaller, lighter turbine-generator system 2200 that imparts less stress on the balloons 2100, 2300 and so requires less maintenance. Reduced maintenance requirement is an important consideration for a system that not accessible regularly.

Each of balloons 2100, 2300 are coupled to and in fluid communication with a condenser/conversion means 2120, 2320. Each condenser/conversion means condenser/conversion means 2120, 2320 is configured to extract water from the surroundings (i.e. moisture from the air convert said water to hydrogen. This hydrogen can be used to maintain buoyancy of the balloons 2100, 2300. The condenser/conversion means 2120, 2320 may be powered by the electricity generated by the turbine-generator system 2200.

From reading the present disclosure, other variations and modifications will be apparent to the skilled person. Such variations and modifications may involve equivalent and other features which are already known in the art of renewable energy, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, and reference signs in the claims shall not be construed as limiting the scope of the claims.

1-32. (canceled)

33. A system for producing electricity from wind energy, comprising:
a balloon configured for inflation with a buoyant gas;
at least one turbine-generator system coupled to the balloon, comprising a turbine and generator, the turbine configured to rotate when subjected to an external airflow, the generator coupled to the turbine and configured to convert rotation of the turbine into electricity; and
an electrical storage system for storing the generated electricity.

34. A system of claim 33, wherein the turbine is a vertical axis wind turbine comprising:
a shaft aligned substantially perpendicular to a ground level; and
a plurality of blades coupled to said shaft.

35. The system of claim 34, wherein the generator is mechanically coupled to the shaft of the turbine.

36. The system of claim 33, wherein the turbine is a horizontal axis wind turbine comprising:
a shaft aligned substantially parallel to a ground level; and
a plurality of blades coupled to said shaft.

37. The system of claim 36, wherein the generator is mechanically coupled to the shaft of the turbine.

38. The system of any claim 33, wherein:
the storage system comprises a power cable coupled between the generator and the storage system; and, optionally or preferably,
wherein the storage system is at a ground level.

39. The system of claim 33, further comprising:
a load cable configured to anchor the turbine-generator system and balloon to the ground; and, optionally or preferably,
a winch fixed at or near ground level, wherein the load cable is coupled to the winch, the winch is configured to wind in or wind out the load cable to adjust a vertical height of the balloon and turbine-generator system above the ground level.

40. The system of claim 37, further comprising:
a load cable configured to anchor the turbine-generator system and balloon to the ground; and, optionally or preferably,
a winch fixed at or near ground level, wherein the load cable is coupled to the winch, the winch is configured to wind in or wind out the load cable to adjust a vertical height of the balloon and turbine-generator system above the ground level; and
wherein the power cable and the load cable are the same cable and/or wherein the power cable and load cable are arranged in the same cable housing.

41. The system of claim 36, further comprising:
a vane coupled to at least one of:
the turbine;
the generator; and/or
the power or load cable (where present).

42. The system of claim 37, further comprising a support frame coupled to the turbine-generator system, wherein:
the support frame is coupled, preferably pivotably, to the power and/or load cable above and below the turbine-generator system, such that the turbine-generator system can rotate freely with respect to the cable(s).

43. The system of claim 42, wherein the support frame further comprises a tilt adjustment system configured to adjust the angle of the turbine relative to the vertical.

44. The system of claim 42, wherein the tilt adjustment system comprises a weighted member coupled to the support frame, wherein the weighted member is configured to bias the turbine-generator system such that the turbine faces substantially perpendicularly to the external airflow, and to balance forces acting on the turbine-generator system.

45. The system of claim 43, wherein the tilt adjustment system comprises first and second arms and wherein the support frame is coupled above and below the turbine-generator system by the first and second arms respectively, and where the first and second arms are adjustably coupled together to form an angle therebetween, and whereby adjustment of the coupling alters the length of the first arm and the angle of the turbine-generator with respect to the second arm to cause the turbine-generator to tilt with respect to the vertical.

46. The system of claim 33, further comprising:
a conversion means to convert water to hydrogen and oxygen gas using any excess generated electricity, situated at or near ground level.

47. The system of claim 46, further comprising:
a water storage tank for storing water for use with the conversion means; and/or
one or more gas storage tanks for storing the hydrogen and oxygen produced by the conversion means, wherein in the case of one gas storage tank, the tank is partitioned to keep the two gases separate; and, optionally or preferably,
a compressor for compressing the produced hydrogen and oxygen for more efficient storage.

48. The system of claim 46, wherein the conversion means is or comprises an electrolyser and/or a fuel cell.

49. The system of claim 33, further comprising a control system configured to adjust several characteristics of the system, including at least one of:
length of uncoiled cable (i.e. height of balloon);
volume of gas used to inflate the balloon;
buoyancy of said gas; and
charging profile for the electrical storage system.

50. The system of claim 47, further comprising a control system configured to adjust several characteristics of the system, including at least one of:
length of uncoiled cable (i.e. height of balloon);
volume of gas used to inflate the balloon;
buoyancy of said gas; and
charging profile for the electrical storage system; and
wherein the control system is further configured to adjust at least one of:
gas compression power;
hydrogen production rate;
water flow rate; and
selection of battery storage/grid export/hydrogen production for the generated electricity.

51. The system of claim 49, further comprising at least one sensor in communication with the control system, configured to measure at least one of:
wind speed;
altitude;
pressure of stored gas; and
force acting on the balloon/load cable.

52. The system of claim 33, further comprising:
a condenser configured to extract water from the surroundings; and
a second conversion means in fluid communication with the condenser, configured to convert the extracted water to hydrogen;
wherein the conversion means is in fluid communication with the balloon, such that the hydrogen produced inflates the balloon.

53. The system of claim 52, wherein the second conversion means is coupled to the mouth of the balloon.
